(19) United States
(12) Patent Application Publication
(10) Pub. No.: US 2009/0268207 A1
(43) Pub. Date: Oct. 29, 2009

(54) REFLECTION MEASUREMENTS ON OPTICAL DISKS

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/908,142

(22) PCT Filed: Mar. 10, 2006
(86) PCT No.: PCT/IB2006/050757

§ 371 Date: Sep. 10, 2007

(30) Foreign Application Priority Data
Mar. 16, 2005 (EP) 05102056.8

(51) Int. Cl. G01N 21/55

(52) U.S. Cl. 356/448

(57) ABSTRACT

The invention makes use of the air-polycarbonate interface of an optical disk as an accurate reflection reference. The air-polycarbonate interface can be used both during production of an optical disk or during normal operation of an optical disk drive. The air-polycarbonate reflection measurement can be used in a number of applications, including the process of identifying an optical disk during normal operation, detecting contamination of the optical disk during use, and testing of an optical disk during manufacture.

The invention relates to a method and apparatus for performing reflection measurements on optical disks, and in particular, to the use of a reflection measurement at the interface between air and the disk substrate as a reflection reference, (i.e. using the air-polycarbonate interface as a reflection reference).

In the field of optical recording there are several situations in which one wants to determine the reflection of an optical disk on a regular basis. For example, the reflection of an optical disk is determined during a manufacturing process to validate the properties of an optical disk. Also, the reflection of an optical disk is determined during normal operation of a disk drive, for example during an initial step of identifying the type of optical disk that has been inserted into the disk drive, or during normal operation of the disk drive to estimate the power incidental on the optical disk. For accurate results it is important that the method employed is reproducible, i.e. that it leads to the same results at different sites (for disk evaluation during manufacture), or in different disk drives (when used during the normal operation of a disk drive).

In order to have reproducible measurements, expensive and complex solutions are currently in place to measure the absolute reflection of an optical disk. Measuring the absolute reflection of an optical disk usually involves an elaborate procedure under well-defined conditions, for example using a parallel beam and measuring the incident and reflected light power.

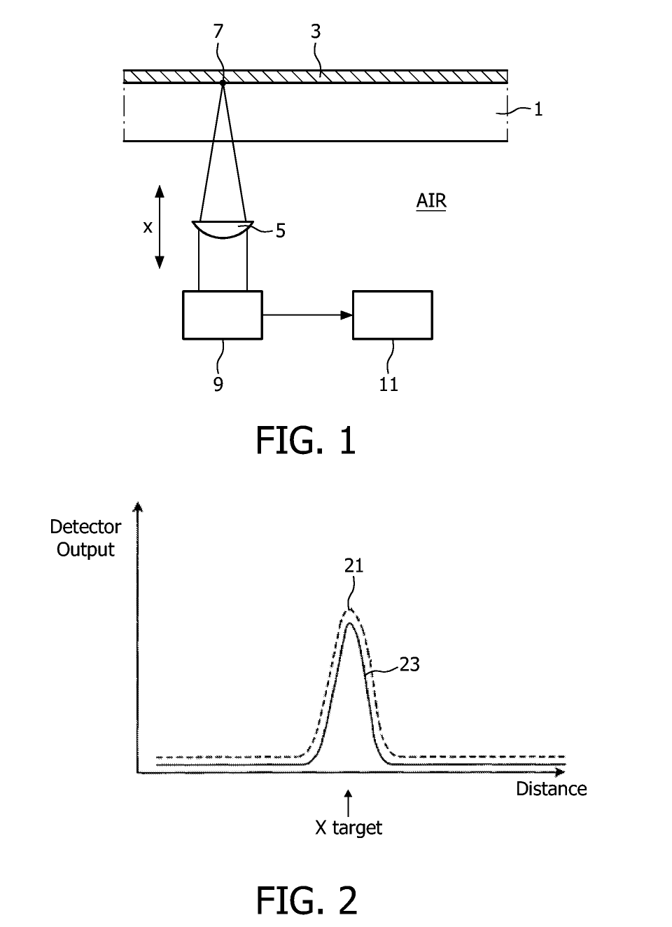

FIG. 1 shows such an arrangement for measuring the absolute reflection of an optical disk 1 having a target information layer 3. An objective lens 5 is ramped in a direction “x” towards the target information layer 3, such that a convergent beam of light is irradiated as a spot 7 on the target information layer 3. A beam splitter 9 receives a reflected beam of light, and provides an output signal to a detector 11. In this way the detector is able to provide an absolute measurement of reflection. However, as mentioned above, this technique suffers from the disadvantage of requiring an extremely accurate knowledge of the power used for the incident beam of light, and an accurate method of measuring the power of the reflected beam. This method also suffers from the disadvantage that any contamination of the disk will result in an inaccurate measurement.

An alternative technique used to validate an optical disk during manufacture is to employ a reference disk or mirror. The arrangement shown in FIG. 1 is used to measure the absolute reflectivity of the reference disk using some elaborate method, with which the reflection of the target disk is compared. With this technique, the apparatus of FIG. 1 is operated such that the objective lens 5 is ramped in the direction “x” such that the focused spot 7 moves through the depth of the disk towards the information layer 3. As shown in FIG. 2, the detector produces an output signal 21 having a peak at point x_{target}, i.e. corresponding to when the focused spot 7 is irradiated on the information layer 3 of the known reference disk. The same operation is then repeated with a target disk which produces an output signal 23 from the detector, also having a peak near the point x_{target}. The reflection of the target disk is then determined by comparing the reflection of the reference disk 21 with the reflection of the target disk 23.

The problem of this approach is that one needs many such reference disks or mirrors for use in different companies or factories. Furthermore, the use of reference disks is not suited where accurate reflection measurements are required during normal operation of a disk drive, as described below.

During normal operation of a disk drive accurate reflection measurements are required when performing a disk recognition process during the initial operation or start-up phase of the disk drive. This is the period in which the optical disk drive attempts to recognize the type of disk that has been loaded into the disk drive, so that the configuration of the disk drive can be set accordingly. The configuration process typically involves setting optimum parameters in various kinds of servo systems (such as the focus and tracking servos), or adjusting the laser power. It will be appreciated that it is important that this operation is carried out as quickly as possible because users desire an almost instant playback of the optical disk, and dislike any delay during the initial start-up phase while the disk drive is attempting to identify the type of optical disk.

This process is becoming more critical as more and more different types of optical disks are being introduced. For example, whereas early optical disk drives only had to distinguish between a handful of different types of optical disks, the presence of CD, DVD, +R, −R, +RW, −RW, double sided disks, combined CD/DVD disks, multi-layer disks, etc., means that many different types of optical disk are currently in existence, with the likelihood of this number increasing even higher.

It is known to make absolute measurements of reflectivity from an information layer of a disk in order to identify the type of disk that has been loaded into a disk drive. US 2002/0159363A1 is an example in which absolute measurements of reflectivity are used together with various thresholds to identify one type of optical disk from another. However, these systems suffer from the disadvantages mentioned above, in that complex and accurate means must be provided to determine the absolute measurements of reflectivity. These techniques also suffer from problems caused by contamination of the disk.

The aim of the present invention is therefore to provide an improved method and apparatus for measuring the reflection of an optical disk. In particular, the aim of the invention is to make use of the reflection from the air to substrate interface as a reflection reference for other reflection measurements and uses, as described in greater detail with reference to the preferred embodiments.

According to a first aspect of the invention there is provided a method of performing reflection measurements from a beam of light incident on an optical disk, the method comprising the steps of measuring the reflection from an air to substrate interface of the optical disk, and using the reflection from the air to substrate interface as a reflection reference for other reflection measurements relating to the disk.

The use of the reflection characteristics at the air to substrate interface has many advantages, as discussed in relation to the specific embodiments.

According to one aspect of the invention, the reflection measurements are made to help identify the type of optical disk, wherein the method comprises the steps of measuring the reflection from a layer within the optical disk, comparing the reflection from the layer within the optical disk with the reflection from the air to substrate interface, and identifying the type of optical disk from the comparison step and an estimated refractive index for the substrate of the optical disk.

This has the advantage of enabling the identity of the disk to be determined based on a comparison step, thereby avoiding the complexities associated with highly accurate absolute measurements.

According to another aspect of the invention, the reflection measurements are made during a manufacturing process, wherein the method comprises the steps of measuring the reflection from a layer within the optical disk, comparing the reflection from the layer within the optical disk with the reflection from the air to substrate interface, and determining if the optical disk is valid based on the comparison step.

Again, this aspect of the invention has the advantage of enabling the quality of the disk to be determined based on a comparison step, thereby avoiding the complexities associated with highly accurate absolute measurements. This aspect also avoids the need for a reference disk.

According to another aspect of the invention, the reflection measurements are made during a manufacturing process, wherein the method comprises the steps of measuring the reflection from the air to substrate interface of a reference disk, comparing the reflection from the air to substrate interface of the optical disk with the reflection from the air to substrate interface of the reference disk, and determining if the disk is valid based on the comparison step.

This aspect of the invention has the advantage of enabling a disk manufacturer to accurately determine the refraction index of a disk substrate without using elaborate equipment.

According to another aspect of the invention, the reflection measurements are made to determine the power of the incident beam of light, wherein the method comprises the steps of retrieving a reflection coefficient relating to the air to substrate interface of the optical disk, and determining the power of the incident beam of light based on the reflection measured from the air to substrate interface and the reflection coefficient of the air to substrate interface.

This aspect has the advantage of enabling the incident power to be easily estimated in circumstances where there is a large tolerance on the laser power.

According to another aspect of the present invention, the reflection measurements are made to determine if there is contamination on the optical disk, wherein the method comprises the steps of retrieving a reflection coefficient relating to the air to substrate interface of the optical disk, measuring the power of the incident beam of light, and determining if the optical disk has been contaminated based on the power of the incident beam of light, the light reflected from the air to substrate interface and the reflection coefficient of the air to substrate interface.

This aspect of the invention allows contamination of the disk to be easily identified using the reflection at the air to substrate interface as a reference.

According to another aspect of the present invention, there is provided an optical disc drive apparatus comprising means for irradiating an incident beam of light onto an optical disk, and means for detecting light reflected from the optical disk, wherein the optical disk drive is adapted to measure the light reflected from the air to substrate interface of the optical disk, and adapted to control the operation of the disk drive according to the light reflected from the air to substrate interface.

According to another aspect of the invention, there is provided an optical disk comprising a parameter indicative of the reflection coefficient of the optical disk stored therein, the parameter relating to the reflection coefficient at the interface between air and a substrate of the optical disk.

For a better understanding of the present invention, and to show more clearly how it may be carried into effect, reference will now be made, by way of example only, to the following drawings in which:

FIG. 1 shows a diagram of a typical system for measuring the reflectivity of an optical disk;

FIG. 2 shows the output from the detector of FIG. 1 when used in conjunction with a reference disk;

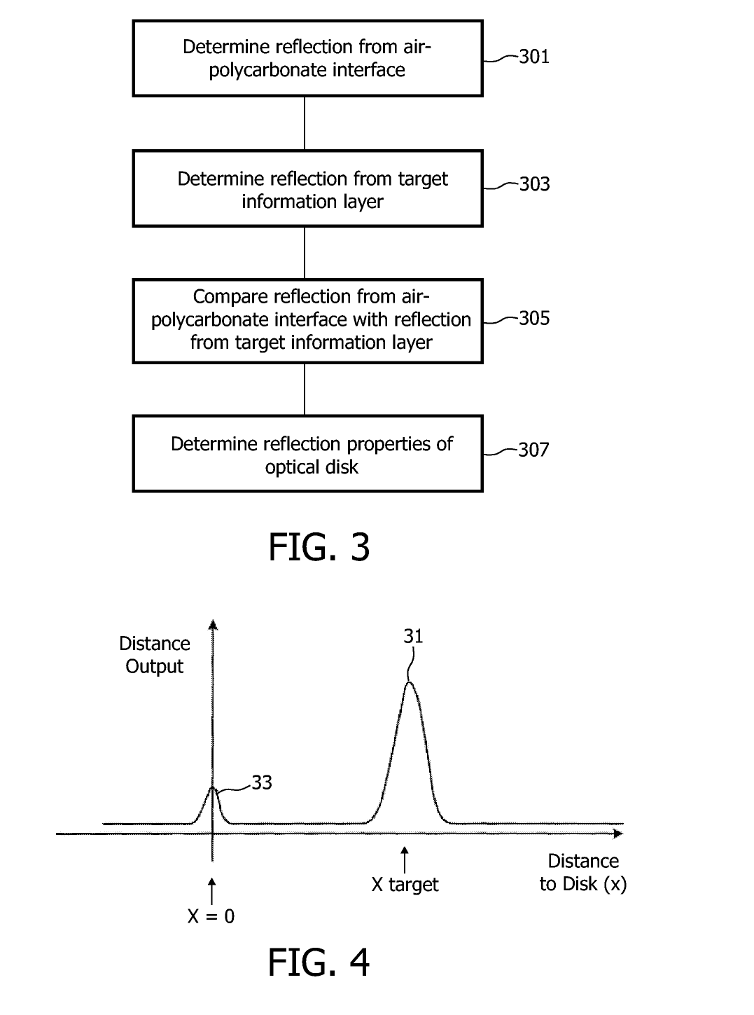

FIG. 3 shows the steps involved with determining the reflection characteristics of a disk according to a first aspect of the present invention;

FIG. 4 shows the reflection measurements used in the method of FIG. 3;

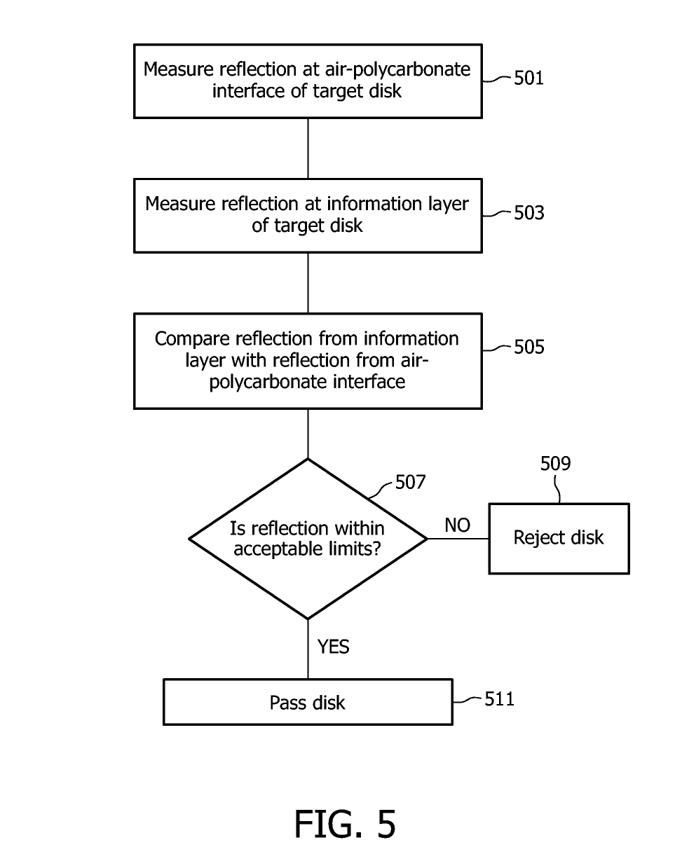

FIG. 5 shows the steps involved with determining the reflection characteristics of a disk according to a second aspect of the present invention;

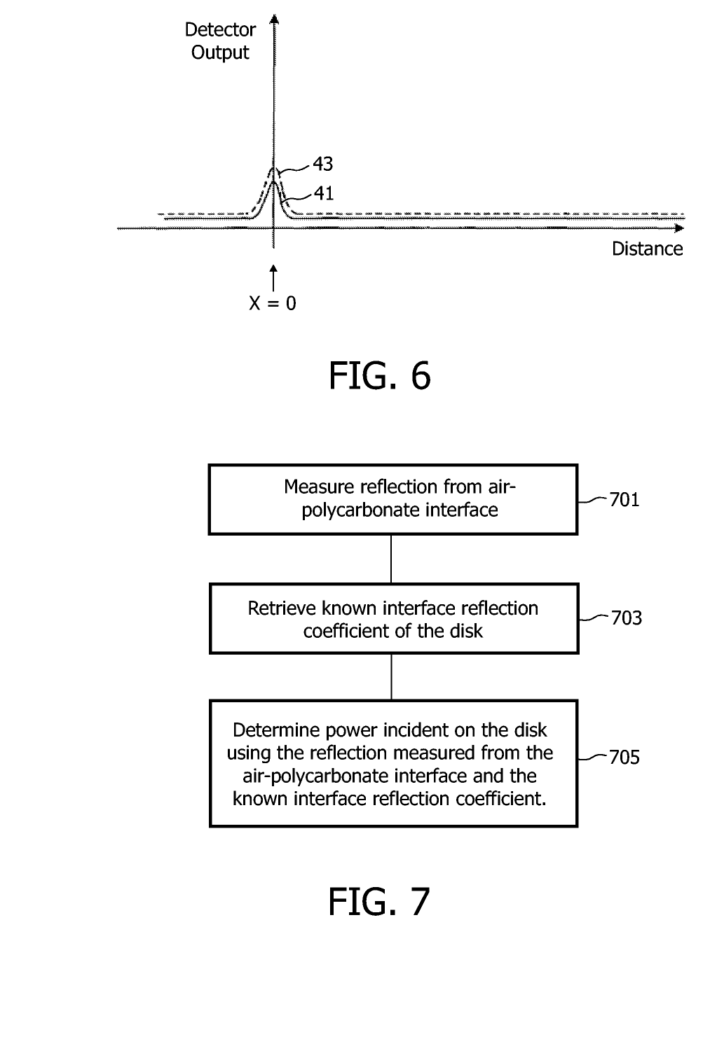

FIG. 6 shows the reflection measurements used in another aspect of the present invention;

FIG. 7 shows the steps involved with determining the incident power on an optical disk according to another aspect of the present invention;

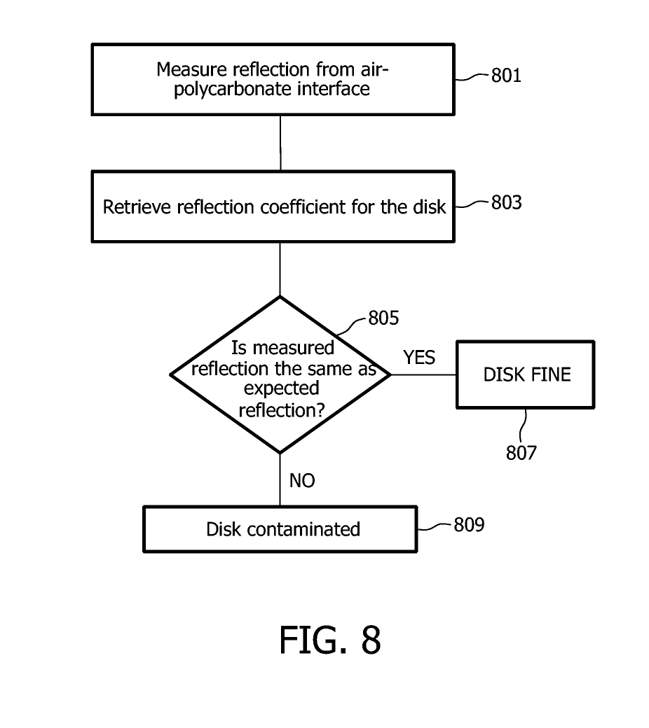

FIG. 8 shows a method according to another aspect of the present invention.

The present invention avoids the problems associated with the prior art by using the reflection at the interface between air and the disk substrate as a reflection reference for various applications. In other words, the invention uses the reflection at the air-polycarbonate interface as a reflection reference.

It will be appreciated that, although the preferred embodiments described hereafter refer to an air-polycarbonate interface, the invention is equally applicable to the interface between air and any disk substrate, e.g. glass or other materials.

An important aspect of the invention relates to the fact that it is quite easy to produce a large number of optical disk substrates with exactly the same refractive index n. Manufacturers often specify the refractive index “n” using 3 or 4 digits after the decimal point. Moreover, these substrates are extremely cheap to manufacture with this level of accuracy.

The reflection coefficient r of the air-polycarbonate interface is given by:

$$r = {( \frac{n - 1}{n + 1} )}^{2}$$

where n is the refractive index of the substrate of the disk. For a typical CD or DVD where the substrate is polycarbonate, the value of n is close to 1.6, giving a reflection coefficient r equal to 5.3%. This leads to the availability of large numbers of identical, accurate and very cheap reflection references, based on the estimated refractive index of n.

The invention will first be described in relation to the use of the reflection reference of the air-polycarbonate interface during normal operation of an optical disk drive, for example when identifying or discriminating the type of optical disk that has been loaded into the disk drive.

FIG. 3 shows the steps involved with this aspect of the invention. As described above in relation to FIG. 1, an objective lens 5 is ramped in the direction “X” so that a beam of incident light is irradiated towards the target optical disk. However, unlike FIG. 1, the apparatus is configured such that the reflection at the air-polycarbonate interface is determined, step 301. In addition to determining the reflection at the air-polycarbonate interface, the reflection from the target information layer is also determined, step 303. The reflection from the air-polycarbonate interface is then used as a reflection reference for comparison with the reflection from the target information layer, step 305. Based on the comparison between the reflection from the air-polycarbonate interface and the reflection from the target information layer, the reflection properties of the optical disk are deduced, step 307. This enables the disk drive to identify the type of disk in a quick and efficient manner. This is made possible due to the fact that, as mentioned above, the reflection at the air to polycarbonate interface is already known. This value is used as an estimated refractive index, for example 1.6, for enabling the identity of the disk to be determined.

FIG. 4 shows the reflection measurements used in the method of FIG. 3. As the incident beam of light is ramped towards the target optical disk a small amount of light is reflected at the interface between the air-polycarbonate interface, corresponding to the distance x=0. This generates a first peak 33 corresponding to the reflection from the air-polycarbonate interface. As the objective lens is ramped further towards the information layer of the target disk, a second peak 31 is generated at position X_{target} corresponding to the reflection from the target information layer. It will be appreciated that, although the amount of light reflected from the target information layer is shown in FIG. 4 as being greater than the amount of light reflected from the air-polycarbonate interface, this is not necessarily always the case. For example, the reflection of the information layers of dual-layer BD-R and BD-RE media is in general lower than their air-polycarbonate interface reflection.

A comparison between the reflection obtained at the air-polycarbonate interface and the reflection at the target information layer is then used to determine the reflection properties of the optical disk, which in turn can be used to detect the type of optical disk that has been inserted into the disk drive.

In other words, if the reflectivity “r” of the information layer is given as:

r=Pr/Pe (i.e. power reflected at the information layer/power emitted) and if the reflectivity “r′” of the air to substrate interface is given as:

r′ =Pr′/Pe′ (i.e. power reflected at the air to substrate interface/power emitted)

then,

r:r′=Pr:Pr′

which means that the reflection r from the information layer can be determined based on the reflection measured from the information layer (Pr), the reflection from the air-substrate interface (Pr′) and the estimated refractive index for the substrate (r′).

Since the reflection measurements are used in a comparison step, i.e. one reflection measurement relative to another, the actual intensity of the incident light beam is no longer an issue, thereby removing this complexity from the measurement process. It is noted that the invention does not require the type of disk to be determined with certainty from its reflection measurements. Instead, the reflection measurements are used for setting parameters that are reflection-dependent, rather than disk-type dependent (e.g. gains, thresholds, etc.). The invention therefore allows the disk recognition process to be made quicker, as it will prompt a correct initial guess in the trial-and-error based identification process. This means that the disk drive does not need to know the value of n with high accuracy. In other words, the invention relies on an estimated value of n for a typical disk. A more accurate measurement is also possible based on obtaining a more accurate value of n, as will be discussed later in the application.

The position of the peaks can also be used to assist with the identification process, whereby the relative position is used to determine the substrate thickness of the disk.

The comparison method described above is also less susceptible to contamination of the optical disk, since both the reflection measurement at the air-polycarbonate interface and the reflection at the information layer will be subject to the same contamination. In other words, the contamination will tend to occur either at the surface of the disk, or in the optical pickup (e.g. on the objective lens), which means that the reflections at the air-polycarbonate interface and information layer will be subject to the same contamination.

It will be appreciated that, although FIG. 4 only shows a first peak 33 and a second peak 31, further peaks may be detected. For example, in a multi-layered disk such as a combined CD/DVD disc having separate CD and DVD information layers, an additional peak will also be present.

Once the method described above has been used to identify the type of optical disk, the disk drive can configure or adjust the settings and parameters of the disk drive so that the data on the disk can be read efficiently. Thereafter, firmware on the optical disk can be read in order to confirm that the disk has been identified correctly, and to make further changes or adjustments to the settings of the disk drive if necessary, or as required.

FIG. 5 shows another aspect of the invention in which the air-polycarbonate interface is used as a reflection reference for testing optical disks during manufacture. In step 501 a reflection measurement is taken from the air-polycarbonate interface of the target disk being tested. Next, in step 503 the reflection is measured at the information layer of the target disk being tested. Thus, according to this aspect of the invention, instead of comparing the reflection from the target information layer with a similar reflection from a reference disk, the invention compares the reflection form the information layer with the reflection from the air-polycarbonate interface, step 505. Based on this comparison the testing equipment can determine if the reflection from the information layer is within acceptable limits, step 507. If not, the disk is rejected, step 509. If the comparison shows that the reflection from the information layer is within acceptable limits, the disk is passed, step 511. In addition to checking the reflection of the information layer, the comparison step can be used more generally to verify that the process conditions for both the substrate and information layer are within limits. Thus, if the reflection ratio falls outside of a predetermined acceptance window, this indicates that there is some fault, either with the information layer or the substrate.

The use of the air-polycarbonate interface as a reflection reference therefore avoids the need for a separate reference disk during testing of optical disks during manufacture.

In an alternative embodiment to the above, the reflection from the air-polycarbonate interface of a target disk can also be used in comparison with the reflection from the air-polycarbonate interface of a reference disk. For example, as shown in FIG. 6, the reflection from the air-polycarbonate interface of a reference disk gives a peak 43, which is compared with the reflection from the air-polycarbonate interface of a target disk having a peak 41. In this manner the testing equipment can check the target disk by simply comparing the reflections from the air-polycarbonate interface of the target and reference disks respectively. This embodiment has the advantage of allowing a disk manufacturer to accurately determine the refraction index of the disk substrate without using elaborate equipment.

Furthermore, during the testing of a batch of optical disks, the disk manufacturer may determine the reflection coefficient r_{batch} at the air-polycarbonate interface of that batch of disks, for example by accurately comparing the incident power with the reflected power. The reflection coefficient r_{batch} for that batch can then be stored on each disk in the batch, for example in the Burst Cutting Area (BCA) or in the Address in Pregroove/Absolute Time in Pregroove (ADIP/ATIP) of each disk, or published elsewhere (for example on the internet or at a website). In addition, or alternatively, the manufacturer can determine and store the layer/substrate ratio plus the ratio of the air-substrate reflections of the target and reference disk, as suggested above.

If the reflection coefficient is known in this way, a disk drive can perform accurate reflection measurements without use of a reference disk, using the air-polycarbonate interface of the disk itself as a reference.

One application of the above is shown in FIG. 7 of the drawings. According to this aspect of the invention the reflection at the air-polycarbonate interface is used to provide an estimate of the power incident on the optical disk. It is often a requirement that the instantaneous power of the light beam is determined during the operation of the disk drive. For example, because an optical disk is sensitive to read power, it is desirable to keep the read power as low as possible, so that the life of the optical disk can be lengthened by increasing the number of read operations that are possible before the disk has to be thrown away. Normally the incident power is determined by having a controlled power loop, but this is based on a factory setting which has problems caused by stray light, or the center spot not being accurate.

In step 701 the reflection from the air-polycarbonate interface is measured. The disk drive then retrieves the known reflection coefficient r_{batch} for that particular disk, step 703. As described above, the reflection coefficient r_{batch} for the disk can be retrieved from data stored on the disk itself, or from data obtained form another source such as the Internet. In step 705 the disk drive is then able to determine the incidental power based on the reflection measured from the air-polycarbonate interface and the known reflection coefficient r_{batch} for the disk.

In other words, if the reflectivity r_{batch} of the substrate is given as:

r_{batch}=Pr/Pe (i.e. power reflected at the air-substrate interface/power emitted) then,

Pe=Pr/r_{batch}

It can be seen from the above that the reflection from the air-polycarbonate interface provides a reflection reference for determining the incidental power, which is useful in situations where there is a large tolerance on the laser power.

According to another aspect of the invention, the refractive index n of an optical disk is stored on the optical disk during manufacture. If the refractive index n is made available in this way, it can be used to further enhance the disk identification and/or incident power measurements described above. For example, since the disk identification process is based on an estimated typical value of n, for example n=1.6, the identification process can be refined by reading the actual value of n from the disk itself.

Therefore, in the case where the refractive index n is stored on the disk, this information can be used for fine tuning a disk drive after an initial measurement has been made to determine the type of disk as described above, i.e. by comparing the ratio of the measurements at the air-polycarbonate interface with the measurement at the information layer. In such an embodiment the type of disk is first determined by comparing the ratio of the reflections at the two points, and then reading the refractive index from the firmware of the disk to allow the disk drive settings to be fine tuned.

According to yet another aspect of the invention, the reflection from the air-polycarbonate interface can be used to detect contamination on the surface of the disk. For example, if the reflection coefficient r_{batch} is known (either form the disk itself or from another source), this information can be used to detect contamination of the disk.

Referring to FIG. 8, the reflection from the air-polycarbonate interface is measured, step 801. The reflection coefficient r_{batch} for that disk is then retrieved, step 803, either from the disk itself or form another source. The reflection measured from the air-polycarbonate interface is then compared with the expected reflection, i.e. using the reflection coefficient and the known incidental power, step 805. If the measured reflection is the same, or within acceptable limits of the expected reflection, then the disk is deemed to be fine, step 807. However, if the measured reflection is not the same as the expected reflection, then this indicates that the disk is contaminated, step 809. In such circumstances the user can be warned that the disk is contaminated so that the disk can be cleaned or replaced.

The invention provides an accurate, easily reproducible and inexpensive reflection reference, and can be used for media verification by disk and drive manufacturers, with excellent reproducibility between companies and manufacturing sites.

It will be appreciated that when certain method steps describe the reflection at the air-polycarbonate interface being measured before the reflection at the information layer, these measurements could equally be performed in reverse, i.e. not just the order specified in the preferred embodiments.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfill the functions of several units recited in the claims. Any reference signs in the claims shall not be construed so as to limit their scope.

1. A method of performing reflection measurements from a beam of light incident on an optical disk, the method comprising the steps of:
measuring the reflection from an air to substrate interface of the optical disk; and
using the reflection from the air to substrate interface as a reflection reference for other reflection measurements relating to the disk.

2. A method as claimed in claim 1, further comprising the steps of:
measuring the reflection from a layer within the optical disk;
comparing the reflection from the layer within the optical disk with the reflection from the air to substrate interface; and
identifying the type of optical disk from the comparison step and an estimated refractive index for the substrate of the optical disk.

3. A method as claimed in claim 1, further comprising the steps of:
measuring the reflection from a layer within the optical disk;
comparing the reflection from the layer within the optical disk with the reflection from the air to substrate interface; and
determining if the optical disk is valid based on the comparison step.

4. A method as claimed in claim 3, wherein the step of determining if the disk is valid further comprises the step of determining if the ratio of the reflection from the layer within the optical disk to the reflection from the air to substrate interface is within a predetermined acceptance window.

5. A method as claimed in claim 1, further comprising the steps of:
measuring the reflection from the air to substrate interface of a reference disk;
comparing the reflection from the air to substrate interface of the optical disk with the reflection from the air to substrate interface of the reference disk; and
determining if the disk is valid based on the comparison step.

6. A method as claimed in claim 1, further comprising the steps of:
retrieving a reflection coefficient relating to the air to substrate interface of the optical disk; and
determining the power of the incident beam of light based on the reflection measured from the air to substrate interface and the reflection coefficient of the air to substrate interface.

7. A method as claimed in claim 1, further comprising the steps of:
retrieving a reflection coefficient relating to the air to substrate interface of the optical disk;
measuring the power of the incident beam of light; and
determining if the optical disk has been contaminated based on the power of the incident beam of light, the light reflected from the air to substrate interface and the reflection coefficient of the air to substrate interface.

8. A method as claimed in claim 6, wherein the reflection coefficient is retrieved from information stored on the optical disk.

9. A method as claimed in claim 6, wherein the reflection coefficient is retrieved from a database via the Internet.

10. An optical disc drive apparatus comprising means for irradiating an incident beam of light onto an optical disk, and means for detecting light reflected from the optical disk, wherein the optical disk drive is adapted to measure the light reflected from the air to substrate interface of the optical disk; and adapted to control the operation of the disk drive according to the light reflected from the air to substrate interface.

11. An optical disk drive as claimed in claim 10, further comprising:
means for measuring the light reflected from a layer within the optical disk drive;
means for comparing the light reflected from the layer within the optical disk with the light reflected from the air to substrate interface; and
means for identifying the type of optical disk based on the comparison between the reflection from the layer within the optical disk and the reflection from the air to substrate interface.

12. A disk drive as claimed in claim 10, further comprising:
means for retrieving a reflection coefficient relating to the air to substrate interface of the disk; and
means for determining the power of the incident beam of light based on the light reflected from the air to substrate interface and the reflection coefficient of the air to substrate interface.

13. A disk drive as claimed in claim 10, further comprising:
means for retrieving a reflection coefficient relating to the air to substrate interface of the disk; and
means for determining if the optical disk has been contaminated based on the power of the incident beam of light, the light reflected from the air to substrate interface and the reflection coefficient of the air to substrate interface.

14. An optical disk comprising a parameter indicative of the reflection coefficient of the optical disk stored therein, the parameter relating to the reflection coefficient at the interface between air and a substrate of the optical disk.

15. An optical disk as claimed in claim 14, wherein the reflection coefficient is stored in the BCA, ADIP or ATIP information of the optical disk.

16. An optical disk as claimed in claim 14, further comprising refractive index information contained therein.
